(19) United States
(12) Patent Application Publication
(10) Pub. No.: US 2025/0010733 A1
(43) Pub. Date: Jan. 9, 2025

(54) MEDIUM-VOLTAGE WIRELESS POWER SYSTEM FOR VEHICLE CHARGING SYSTEMS

(71) Applicant: UT-Battelle, LLC, Oak Ridge, TN (US)

(72) Inventors: Omer C. Onar, Knoxville, TN (US); Veda Prakash Galigekere, Knoxville, TN (US); Rong Zeng, San Diego, CA (US); Burak Ozpineci, Knoxville, TN (US)

(21) Appl. No.: 18/762,806

(22) Filed: Jul. 3, 2024

Related U.S. Application Data
(60) Provisional application No. 63/524,972, filed on Jul. 5, 2023.

(51) Int. Cl. B60L 53/122; H02J 50/12; H02M 3/335; H02M 7/5387

(52) U.S. Cl. CPC B60L 53/122; H02J 50/12; H02M 3/33576; B60L 2210/10; B60L 2210/42; H02M 7/5387

(57) ABSTRACT

A system for transferring power wirelessly in a dynamic or stationary environment with a modular converter configuration. The system may include a grid interface operable to receive power from a power source, such as a three-phase grid power source, and provide power to the modular converter configuration.

### STATEMENT REGARDING FEDERALLY SPONSORED RESEARCH AND DEVELOPMENT

This invention was made with government support under Contract No. DE-AC05-00OR22725 awarded by the U.S. Department of Energy and under Contract No. 0000-Z340-19 awarded by the Defense Threat Reduction Agency of the U.S. Department of Defense. The government has certain rights in the invention.

### FIELD OF INVENTION

The present disclosure relates to the field of wireless charging, and more particularly to a modular wireless charging system.

### BACKGROUND

Electric vehicle (EV) wireless charging technology, also known as wireless power transfer (WPT), has drawn attention due to its advantages of simplicity, reliability, safety, and user friendliness. As one type of WPT, Dynamic WPT (DWPT) may enable EVs to be charged in motion in an effort to considerably reduce the on-board battery size and extend the driving range.

A conventional road-side unit of a DWPT system may include a grid interface, a full-bridge converter, a resonant network, and a transmitter coil.

When the vehicle is approaching the transmitter coil in a conventional arrangement, the grid interface converts the AC grid voltage to DC voltage, which is then converted by a full-bridge converter to be a high-frequency AC voltage, e.g., 85 kHz. The high-frequency AC voltage goes through the resonant network to generate a high-frequency current that finally flows into the transmitter coil. The charging power has a square relationship with the mutual inductance between the transmitter and receiver coils. Since the mutual inductance changes according to the relative position of the receiver coil to the transmitter coil, the load profile of DWPT is variable depending upon the speed of the approaching vehicle. A charging window of a single transmitter coil can be very short, e.g., tens of milliseconds, thus the system power transfer capability must be increased by the high-power DWPT.

In practice, the conventional arrangement of a DWPT system, the grid current for a 70-mile-per-hour case has a large second harmonic component (e.g., 0.4 p.u.). Such a variable vehicle-speed-related pulse-like load profile and second harmonics may cause considerable stress to the AC grid, particularly in the case of low-voltage distribution networks. To mitigate the grid impact, smart grid architectures and demand side management have been conventionally proposed. Also, energy storage, renewable energy, and vehicle-to-grid (V2G) power transfer were integrated to minimize the demand variability and grid impact. These conventional solutions are based on low-voltage power grids, e.g., up to 480V, where costly and bulky low-frequency step-down transformers are required to access the power system.

To facilitate the development of high-power fast or extreme fast charging technologies to greatly reduce the charging time of EVs, one conventional effort has involved use of a direct connection to a medium-voltage grid to avoid using the low-frequency step-down transformer, and at the same time increase the power conversion efficiency. Another conventional effort has involved use of an architecture based on a cascaded H-bridge (CHB) multilevel converter for medium voltage fast charging stations. Ultrafast charging speed can be realized with good charging performance, however the function of charging in motion has not been achieved by these conventional solutions.

Another conventional effort has been directed to high-power dynamic wireless charging with a charging system architecture feeding from medium-voltage railway grid (e.g., a 3 kV grid), with dual active bridge topology used to regulate the energy flow. The shortcoming of this conventional solution is that it must be set up along with the railway grid, and the impacts to the railway grid have not been analyzed.

### SUMMARY

In general, one innovative aspect of the subject matter described herein can be embodied in an off-board module of a dynamic wireless power transfer (DWPT) system for providing high-frequency AC power to an electric vehicle (EV). The off-board module may include a high-voltage bus, a grid-interface module electrically connected at its input directly to a grid that provides three-phase AC voltage with a medium amplitude and at its output directly to the high-voltage bus. The grid-interface module may be configured to convert the three-phase AC voltage with the medium amplitude to a DC voltage having a high amplitude that is larger than the medium amplitude of the three-phase AC voltage, and to output the DC voltage with the high amplitude to the high-voltage bus. The module may include a low-voltage bus with a DC capacitance C_{dc}, and a DC/DC converter module electrically connected at its input directly to the high-voltage bus and at its output directly to the low-voltage bus. The DC/DC converter module may be configured to convert the DC voltage with the high amplitude to a DC voltage with a low amplitude that is less than the medium amplitude of the three-phase AC voltage, and to output the DC voltage with the low amplitude to the low-voltage bus. The module may include a resonant network configured to produce a high-frequency AC current from a high-frequency AC voltage. The module may also include a DC/AC converter or inverter electrically connected between the low-voltage bus and the resonant network, where the DC/AC converter is configured to convert the DC voltage with the low amplitude to the high-frequency AC voltage. The module may include a primary coil electrically connected to the resonant network and configured to wirelessly transmit the high-frequency AC power corresponding to the high-frequency AC current to a pick-up coil of an onboard module of the DWPT system, when the pick-up coil is adjacent to the primary coil over a time interval during which the EV moves by the primary coil.

The foregoing and other embodiments can each optionally include one or more of the following features, alone or in combination. In particular, one embodiment includes all the following features in combination.

In some embodiments, the grid-interface module may include three arms in one-to-one correspondence to the AC voltage's three-phases, and each arm may include N submodules, where N≥2, and each of the N submodules includes a respective half-bridge converter and a respective energy unit.

In some embodiments, the off-board module energy unit may include a battery or a supercapacitor.

In some embodiments, the off-board module DC/DC converter module may be arranged based on a series-input-parallel-output topology and may include K blocks connected in series with each other, where K≥2, each of the K blocks includes a single-phase modular multilevel converter (MMC) at its primary side and a respective set of one or more single-phase active rectifiers at its secondary side. Each arm of the single-phase MMC may include M submodules, where M≥2, and each of the M submodules may include a respective half-bridge converter and a respective capacitor.

In some embodiments, the off-board module DC/DC converter module may be arranged based on a series-input-parallel-output topology and may include K blocks connected in series with each other, where K≥2. Each of the K blocks may include a single-phase modular multilevel converter (MMC) at its primary side and a respective set of one or more single-phase active rectifiers at its secondary side. Each arm of the single-phase MMC may include M submodules, where M≥2, and each of the M submodules may include a respective half-bridge converter and a respective capacitor.

In some embodiments, the off-board module may include K copies of the DC/AC converter in one-to-one correspondence with the K blocks of the DC/DC converter module, and respective K copies of the resonant network and respective K copies of the primary coil to enable the DWPT system to provide the high-frequency AC power concurrently up to K EV vehicles.

In some embodiments, the off-board module may include a grid-interface controller communicatively coupled with, and configured to drive, the grid-interface module including a plurality of submodules in at least two arms of the grid-interface, and may include a DC/DC converter controller communicatively coupled with, and configured to drive, the DC/DC converter module including a plurality of submodules in at least two arms of the DC/DC converter.

In some embodiments, the grid-interface controller may be configured to drive the grid-interface module to control the flow of power from an energy source of the plurality of submodules to the respective arm of the grid-interface.

In some embodiments, the fundamental component of the high-frequency AC power has a frequency band covering center operating frequency of 85 kHz.

In some embodiments, a dynamic wireless power transfer (DWPT) system may include the off-board module and one or more on-board modules carried by respective EVs. Each on-board module may include a respective pick-up coil configured to receive the high-frequency power when the pick-up coil is adjacent to a corresponding copy of the primary coil over a time interval during which the EV carrying the on-board module moves by the corresponding copy of the primary coil. The on-board module may include a respective rectifier configured to provide DC power based on the received high-frequency power.

In some embodiments, the DWPT system may include more than one block. For instance, the DWPT system may include at least two, three, four, five, six, or seven or more blocks.

In some embodiments, an extra fast charging (XFC) system for wirelessly providing AC power to an electric vehicle (EV) may be provided. The XFC system may include the DWPT system.

In general, one innovative aspect of the subject matter described herein can be embodied in a wireless power supply for a remote device. The wireless power supply may include a high-voltage bus, and a power source interface operable to couple directly to a grid power source that provides three-phase AC voltage with a first AC amplitude. The power supply interface may be configured to convert the three-phase AC voltage to output a first DC voltage level on a first DC bus. The wireless power supply may include a converter electrically coupled to the output of the power source interface, where the converter may be configured to convert the first DC voltage level to a second DC voltage level on a second DC bus, and where the converter may include a plurality of converter modules each including a converter module output coupled to the second DC bus. Each of the converter modules may be configured to provide the second DC voltage level to the converter module output.

The wireless power supply may include a first wireless power transmitter and first switching circuitry operably coupled to the second DC bus and the first wireless power transmitter. The first switching circuitry may be configured to drive the first wireless power transmitter with power obtained from the second DC bus to transmit power wirelessly to the remote device.

The foregoing and other embodiments can each optionally include one or more of the following features, alone or in combination. In particular, one embodiment includes all the following features in combination.

In some embodiments, the power source interface may include a grid-interface electrically connected at its input directly to the grid power source that provides the three-phase AC voltage, where the grid-interface may be configured to convert the three-phase AC voltage to a first DC voltage with the first DC voltage level, and to output the first DC voltage to the output of the power supply interface. The wireless power supply may include a DC capacitance C_{dc} coupled to the second DC bus, and the first wireless power transmitter may include a first resonant network and a primary coil. The wireless power supply may include a DC/AC converter electrically connected between the second DC bus and the first resonant network, and where the primary coil may be configured to wirelessly transmit power to a pick-up coil of an on-board module when the pick-up coil is adjacent to the primary coil over a time interval during which the remote device moves by the primary coil.

In some embodiments, the first DC level may be greater than the first AC amplitude, and wherein the first DC level may be greater than the second DC level.

In some embodiments, the wireless power supply may include a second wireless power transmitter and second switching circuitry operably coupled to the second DC bus and the second wireless power transmitter. The second switching circuitry may be configured to drive the second wireless power transmitter with power obtained from the second DC bus to transmit power wirelessly to the remote device.

In some embodiments, the plurality of converter modules may be provided in a series arrangement with the first DC bus.

In some embodiments, the power source interface may include three arms in one-to-one correspondence to the AC voltage's three-phases; each arm includes N submodules, where N≥2; and each of the N submodules includes a respective half-bridge converter and a respective energy unit.

In some embodiments, each of the plurality of converter modules may include a single-phase modular multilevel converter (MMC) at its primary side and a respective set of one or more single-phase active rectifiers at its secondary side.

In some embodiments, each arm of the single-phase MMC may include M submodules, where M≥2. Each of the M submodules may include a respective half-bridge converter and a respective capacitor.

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components. Any reference to claim elements as “at least one of X, Y and Z” is meant to include any one of X, Y or Z individually, and any combination of X, Y and Z, for example, X, Y, Z; X, Y; X, Z; and Y, Z.

### BRIEF DESCRIPTION OF THE DRAWINGS

FIG. 1 shows a system according to one embodiment.

FIG. 2 shows an equivalent circuit for purposes of discussion according to one embodiment.

FIG. 3 shows an equivalent circuit for purposes of discussion according to one embodiment.

FIG. 4 shows at least a portion of a control system according to one embodiment.

FIG. 5 shows an equivalent circuit for purposes of discussion according to one embodiment.

FIG. 6 shows at least a portion of a control system according to one embodiment.

FIG. 7 shows pulse shaping according to the control system in one embodiment.

FIG. 8 shows at least a portion of a control system according to one embodiment.

### DETAILED DESCRIPTION

A system according to one embodiment provides a reliable and flexible grid integration topology for charging stations (e.g., an extreme fast charging (XFC) station) to mitigate the grid impact and reduce the cost of the entire system. In one embodiment, a system is provided for transferring power wirelessly in a dynamic or stationary environment with a modular converter configuration. The system may include a grid interface operable to receive power from a power source, such as a three-phase grid power source, and provide power to the modular converter configuration.

In one embodiment, a three-phase modular multilevel converter (MMC) based grid interface may be directly connected to a medium-voltage AC grid without a step-down transformer. In the three-phase grid interface, each arm may include N submodules (SMs), and each SM may include a half-bridge converter. To reshape the load profile of the system, an energy unit, e.g., battery or supercapacitor, may be embedded into each SM. The main functions of grid interface may be to help keep the high-voltage DC-bus voltage stable and regulate the active and reactive powers to the medium-voltage AC grid.

The isolated DC/DC converter may include a series-input-parallel-output topology based on single-phase MMC, and a single-phase active rectifier to provide galvanic isolation and generate low-voltage DC voltage. A modular high-frequency link (HFL) may include K blocks. Each block may include a single-phase MMC at the primary side and one or multiple single-phase active rectifiers at the secondary side. Each arm in the single-phase MMC may include M SMs, and each SM may include a half-bridge converter with a capacitor. The series-input configuration at a high-voltage (HV) DC-bus side (e.g., from the grid interface) may significantly reduce the voltage stress on each block. With the MMC on distributed DC capacitor, the modular HFL topology may not require series-connected capacitors at the HV DC-bus side.

Due to the modular design, the system may provide fault-tolerant capabilities. When a fault happens in an SM, a redundant SM may replace the faulty one and ensure the continuous operation of the single-phase MMC.

The distributed high-frequency transformers may reduce the manufacturing challenges compared with one high-power high-frequency transformer with a back-to-back MMC topology, and the distributed transformer arrangement may also enhance the reliability of the system. A multi-winding transformer, in one embodiment, can be used to connect with multiple active rectifiers to enhance the fault-tolerant capability at a rectifier side (e.g., an active rectifier side). In case a fault happens on a distributed high-frequency transformer, a redundant block can be used to provide reliability in the system. The single-phase MMC may generate constant high-frequency AC voltage, which goes through the step-down transformer and rectifier to generate a stable low-voltage (LV) DC-bus voltage. A charging system may be connected to the LV DC bus.

In one embodiment, the system may directly connect to a medium-voltage distribution power grid, avoiding a bulky and costly step-down transformer used in a conventional grid integration configuration.

In one embodiment, the system may provide a modular configuration, so it can provide high reliability and fault tolerant capability.

In one embodiment, compared with a cascaded H-bright (CHB) topology, MMC may not utilize a multi-pulse transformer to provide galvanic isolated DC voltages for SMs, which is more efficient and suitable for high- and medium-voltage applications, e.g., 13.8 kV.

In one embodiment, a renewable energy resource can be integrated into the system, which may potentially reduce the cost of the system, mitigate the negative impact to utility, and provide additional environment friendliness.

The system in one embodiment may be used generally in fields such as energy and utilities, or transportation. For instance, the system can be used for extreme fast charging stations for electric vehicles.

In one embodiment, a medium-voltage system based on a modular multilevel converter (MMC) is provided for high-power dynamic wireless charging systems. The system may include a grid interface and modular high-frequency link (HFL) topologies. The grid interface may be based on a three-phase MMC topology to directly connect to the medium-voltage grid.

To reduce the power stress to the grid, in one embodiment, battery energy storage systems (BESSs) may be integrated into submodules (SMs) of an MMC-based grid interface to reshape the load profile of the charging system. The modular HFL may be based on a series-input parallel-output DC/DC topology to provide galvanic isolation. For each block, the primary side may adopt a single-phase MMC to generate a high-frequency AC voltage, and an active rectifier may be used at the secondary side to supply the low-voltage DC bus. This configuration may provide high reliability for a dynamic wireless charging system.

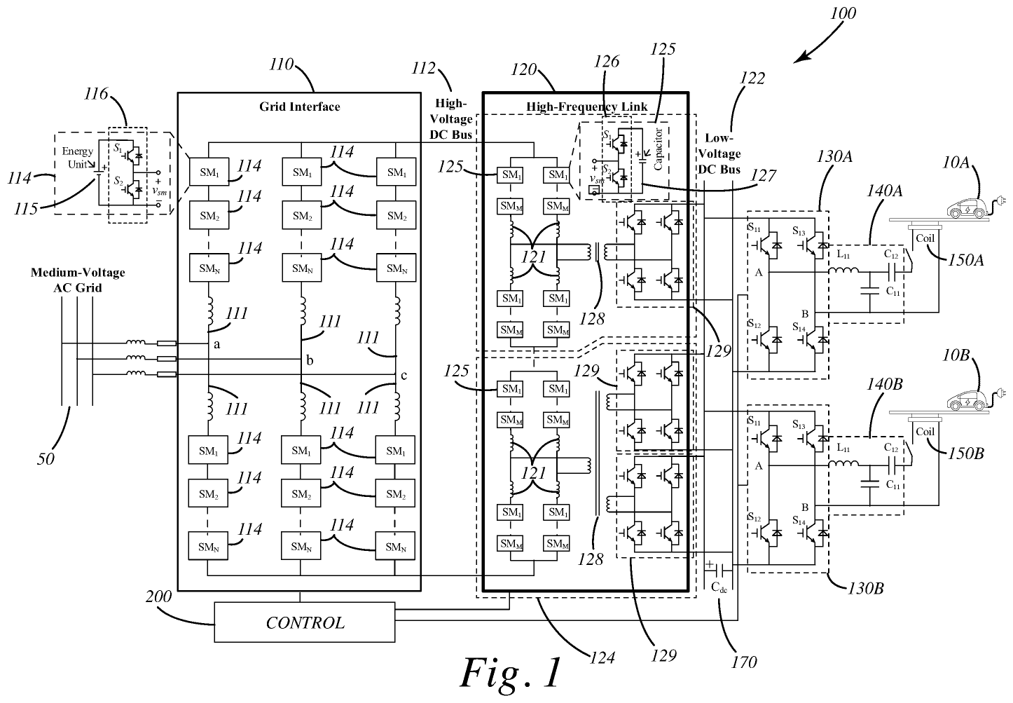

In the illustrated embodiment of FIG. 1, a system 100 for transferring power wirelessly in a dynamic environment is provided. The system 100 includes a grid interface 110 operable to receive power from a power source 50, such as a three-phase grid power source. The system 100 may include a converter 120 (e.g., a DC/DC converter) and a plurality of inverters 130A-B coupled to the converter 120. Each of the plurality of inverters 130A-B may be coupled to a transmitter 150A-B, directly or indirectly (e.g., via compensation circuitry 140A [also described as a resonant network]). The transmitter 150A-B may provide power wirelessly to a remote device 10A-B, such as a vehicle (although it is to be understood that the present disclosure is not limited to a vehicle and may be provided as a wireless power system for any type of remote device, such as a portable electric device or cellphone). The converter 120 may be operable to supply power to a second DC bus 122 from a first DC bus 112, which may be powered by the grid interface 110. The second DC bus 122 may be a low-voltage DC bus, and the first DC bus 112 may be a high-voltage DC bus. The second DC bus 122 may be coupled to a bulk capacitor 170, labeled C_{dc} that is operable to filter variations in voltage on the second DC bus 122.

In one embodiment, the grid interface 110 is a three-phase MMC-based grid interface that may be directly connected to a power source 50 in the form of a medium-voltage AC grid. The grid interface 110 may be coupled to the power source 50 without a step-down transformer. In configurations of the grid interface 110 with a three-phase grid interface, the grid interface 110 may include a plurality of arms 111 coupled respectively to each of the three legs A, B, C of the power source 50.

Each arm 111 may include one or more submodules (SMs) 114 (e.g., N number of SMs), and each of the SMs 114 may be configured to facilitate reshaping a load profile of the system 100 (e.g., a DWPT system). In one embodiment, each of the SMs 114 may include a half-bridge converter 116 and an energy source 114. The half-bridge converter 116 may be operable to receive power from the energy source 114 and supply power to the respective arm 111. The energy source 114 may be embedded in the SM 114. The primary role of the grid interface 110 may be to maintain the voltage (e.g., a high-voltage) on the first DC bus 112 in a stable condition and to regulate the active and reactive powers to the power source 50 (e.g., the medium-voltage AC grid).

The energy source 114 may vary from application to application. For instance, the energy source 114 may include one or more of a battery and a supercapacitor-however, any type or number of sources of power may be provided in the energy source 114. The SMs 114 of the grid interface 110 may be configured similarly with the same energy source configuration. Alternatively, one or more SMs 114 of the grid interface 110 may be different from another of the SMs 114 of the grid interface 110.

In one embodiment, the converter 120 may be configured as an isolated converter to substantially isolate the first DC bus 112 from the second DC bus 122. For instance, the converter 120 may galvanically isolate the second DC bus 122 from the first DC bus 112. The converter 120, in one embodiment, may be provided in a series-input-parallel-output topology based on single-phase MMC and a single-phase active rectifier to provide galvanic isolation and generate low-voltage DC voltage for the second DC bus 122. The converter 120 may be provided in a modular form including one or more converter blocks 124 or modules (e.g., K basic blocks). Each converter block 124, in one embodiment, has a single-phase MMC at a primary side and one or multiple single-phase active rectifiers at a secondary side. Each arm 121 in the single-phase MMC may include one or more SMs 125 (e.g., M SMs) similar in some respects to the SM 114, such as including an energy source 127 and a converter 126 (e.g., a half-bridge converter). The energy source 127 may vary from application to application and may be any type of power source, similar to the energy source 115 of the SM 114. For instance, the energy source 127 may correspond to a capacitor.

The converter blocks 124 in the illustrated embodiment include a transformer 128 with the primary side of the transformer 128 being coupled to the plurality of SMs 125 via the arms 121, and with the secondary side of the transformer 128 being coupled to one or more rectifiers 129. The transformer 128 may include one or more primary side windings and one or more secondary side windings.

The series-input configuration of the converter blocks 124 coupled to the first DC bus 112 may help to significantly reduce the voltage stress on each of the converter block 125. For instance, with the feature of an MMC configuration for the converter blocks 124 on distributed DC capacitor, the converter 120 topology may avoid use of series-connected capacitors at the first DC bus 112 (e.g., at a high-voltage bus side).

Due to the modular design, converter 120 topology may provide excellent fault-tolerant capability. As an example, when a fault happens in an SM 125, a redundant SM 125 may replace the faulty one and ensure the continuous operation of single-phase MMC. The construction of the converter block 124 (e.g., including the transformer 128) may reduce manufacturing difficulty compared with a single high-power high-frequency converter or transformer with back-to-back MMC topology, and the converter block 124 may also improve the reliability of the whole system 100.

In one embodiment, as described herein, the transformer 128 may be a multi-winding transformer used to connect with multiple rectifiers 129 (e.g., active rectifiers) to enhance the fault-tolerant capability at the rectifier side. For instance, in case a fault happens on a distributed high-frequency transformer 128 or converter block 124, a redundant converter block 128 can be used instead to enhance the reliability of the DWPT system 100. The rectifier 129, as described herein, may be an active rectifier with a plurality of switches that are actively controlled to rectify the input AC voltage to DC voltage—although alternatively, the rectifier 129 may be configured as a passive rectifier.

In one embodiment, one function of the converter block 124 in the form of a single-phase MMC is to generate constant high-frequency AC voltage, which goes through the step-down transformer 128 and an active rectifier 129 to generate a stable low-voltage (LV) dc-bus voltage for the second DC bus 122. A charging system for a remote device 10A-B in one embodiment may be connected to the second DC bus 122.

The system 100 according to one embodiment can also be used for a stationary charging station, such as an extra fast charging (XFC) station. Such a station may be connected to a DC bus with at least 680V (e.g., for 480V three phase AC), and each charger may provide up to 500 KW (e.g., for 480V three phase AC with a 600A service) power to a remote device 10A-B. In one embodiment, the architecture and control strategy may be substantially the same for a DWPT system 100 and an XFC system, while the DWPT system 100 may have a much shorter charging window, e.g., milliseconds in the DWPT system 100 versus minutes in XFC system, thus greater impacts to the power grid can be caused.

The topology of the converter 120 according to one embodiment is MMC. The operational principles of the MMC-based converter 120 are described in further detail herein. For the equivalent circuit of one-phase MMC shown in FIG. 2, the SMs 125 in the upper and lower arms 121 can be considered as two voltage sources vₚ and vₙ.

According to Kirchhoff's current law, the arm current iₚ and iₙ can be written as

$$\{ \begin{matrix}{i}_{p} = {i}_{o} / 2 + {i}_{c c} \\ {i}_{n} = - {i}_{o} / 2 + {i}_{c c}\end{matrix} . \qquad ( 1 )$$

where i_{cc} is the circulating current flowing through the upper and lower arms 121. It has no effect on the output current iₒ and can be expressed as

$${i}_{c c} = ( {i}_{p} + {i}_{n} ) / 2 . \qquad ( 2 )$$

The relationships among arm, AC and DC voltages are,

$$\{ \begin{matrix}{v}_{a c} = {v}_{d c} / 2 - {v}_{p} - {Ldi}_{p} / dt - {Ri}_{p} \\ {v}_{a c} = - {v}_{d c} / 2 + {v}_{n} + {Ldi}_{n} / dt + R {i}_{n}\end{matrix} . \qquad ( 3 )$$

Substituting (1) and (2) into (3) yields

$$\{ \begin{matrix}{v}_{p} + {v}_{n} = {v}_{d c} - 2 {Ldi}_{c c} / dt - R {i}_{c c} \\ {v}_{n} - {v}_{p} = 2 {v}_{a c} + {Ldi}_{o} / dt + R {i}_{o}\end{matrix} . \qquad ( 4 )$$

From (4), the DC voltage v_{dc} can be regulated by the sum of the upper arm voltage vₚ and the lower arm voltage vₙ, and the output current can be controlled by the difference between the upper and lower arm voltages. With the output current regulation, the absorbed power from the AC grid can be controlled.

A control system 200 according to one embodiment may involve control over the grid interface 110 and/or the converter 120 to control transmission of power wirelessly to a remote device 10 based on power received from the power source 50.

In one embodiment, the grid interface 110 may be operable to 1) keeping voltage on the first DC bus 112 stable (e.g., keeping the high-voltage DC bus stable); 2) managing the energy units 115 in the SMs 114. For the modular converter 120, it is helpful to stabilize the amplitude and frequency of high-frequency output voltage. Additionally, it is helpful to substantially equalize the distributions of voltage of the first DC bus 112 among the series-connected converter blocks 124 (e.g., single-phase MMCs).

For a grid interface 110, according to one embodiment, the upper and lower arm voltages can be derived from (3),

$$\{ \begin{matrix}{v}_{p} = {v}_{d c} / 2 - {v}_{a c} - {Ldi}_{p} / dt - R {i}_{p} \\ {v}_{n} = {v}_{d c} / 2 + {v}_{a c} - {Ldi}_{n} / dt - R {i}_{n}\end{matrix} . \qquad ( 5 )$$

Following (1) and (5), the powers flowing through the upper and lower arms 121 are calculated as

$$\{ \begin{matrix}{p}_{p} = {v}_{p} \times {i}_{p} = ( {v}_{d c} / 2 - {v}_{a c} - {Ldi}_{p} / dt - R {i}_{p} ) \times {i}_{p} \\ {p}_{n} = {v}_{n} \times {i}_{n} = ( {v}_{d c} / 2 + {v}_{a c} - {Ldi}_{n} / dt - R {i}_{n} ) \times {i}_{n}\end{matrix} . \qquad ( 6 )$$

Substituting (1) into (6) and integrating the instantaneous power into one fundamental period, and by ignoring the power loss on resistor R, the net energy flowing into the upper-arm and lower-arm SMs 114 is

$$\{ \begin{matrix}{E}_{p} = \int {p}_{p} dt = \int ( {v}_{d c} {i}_{o} / 4 + {v}_{d c} {i}_{c c} / 2 - {v}_{a c} {i}_{o} / 2 - {v}_{a c} {i}_{cc} ) dt \\ {E}_{n} = \int {p}_{n} dt = \int ( - {v}_{d c} {i}_{o} / 4 + {v}_{d c} {i}_{c c} / 2 - {v}_{a c} {i}_{o} / 2 + {v}_{a c} {i}_{c c} ) dt\end{matrix} . \qquad ( 7 )$$

Thus, the total energy in one phase and the energy difference between the upper and lower arms 121 can be calculated as

$$\{ \begin{matrix}{E}_{p} + {E}_{n} = \int ( {v}_{d c} {i}_{c c} - {v}_{a c} {i}_{o} ) dt \\ {E}_{p} - {E}_{n} = \int ( {v}_{d c} {i}_{o} / 2 - 2 {v}_{a c} {i}_{c c} ) dt\end{matrix} . \qquad ( 8 )$$

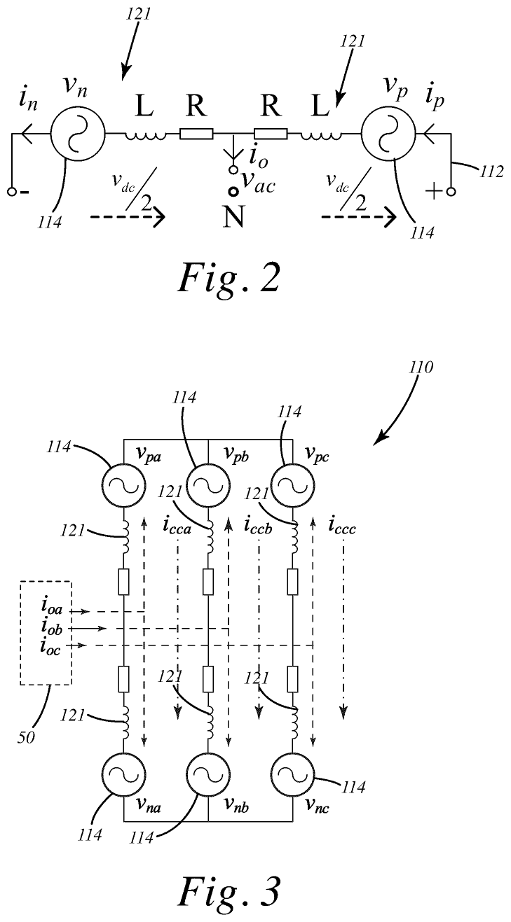

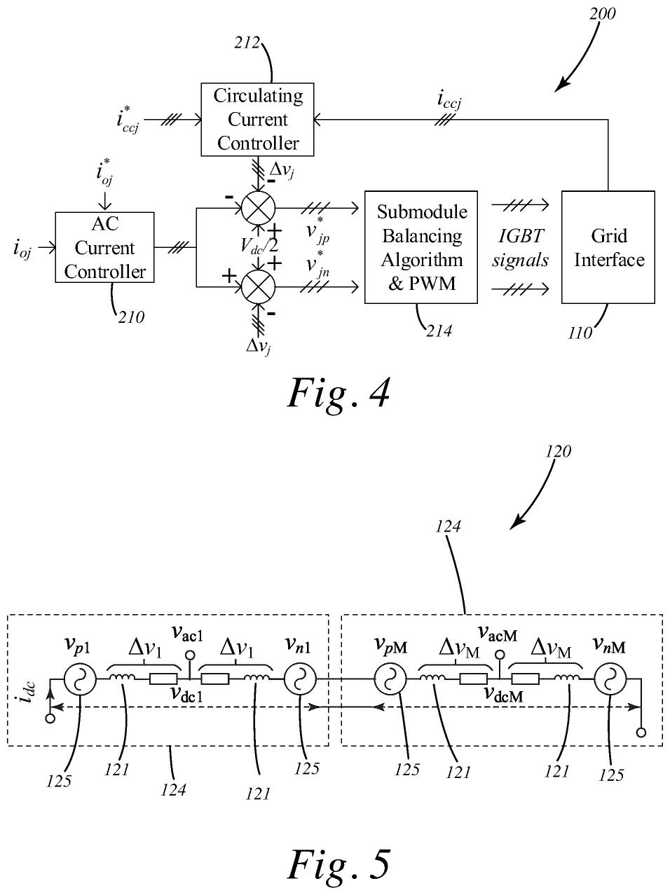

From (8), the total energy in one phase can be derived from the AC and DC sides. Assuming there is no DC source at the DC side, the AC current iₒ can be used to regulate the power flowing from the power source 50 (e.g., a medium-voltage AC grid) into the energy units 115 in SMs 114. For the energy difference, a circulating current with the same frequency of v_{ac} can be injected to dispatch the energy among the upper and lower arms 121. Therefore, the power flows of energy units 115 among different arms can be regulated separately, as shown in FIG. 3.

Based on the description herein, control of the grid interface 110 according to one embodiment may include the AC current control loop and circulating current control loop. At least a portion of the control system 200 for controlling the grid interface 110 in one embodiment is shown in FIG. 6, where the superscript “*” denotes reference values and j stands for phases a, b, c. vⱼₚ*, vⱼₙ* indicate the reference upper and lower arm voltages, and i₀ⱼ, i_{ccj} represent the AC current and circulating current.

The control system 200 may be coupled to and operable to direct operation of one or more components of the system 100, including one or more of the grid interface 110, the converter 120, and the inverters 130A-B. The control system 200 may vary from application to application.

The inverters 130A-B in the illustrated embodiment of FIG. 1 includes an H-bridge inverter configuration (e.g., a full bridge) with first, second, third, and fourth switches S1, S2, S3, S4 capable of operating in conjunction with each other to supply power to a respective transmitter 150A.

The inverters 130A-B (e.g., switching circuitry) may be configured to receive input power from the second DC bus 122, and to generate AC power to be supplied to the transmitter 150A. The control system 200 may direct operation of the inverters 130A-B according to a switching frequency and duty cycle (pulse width) to generate the high-frequency AC power. The switching frequency may be between 3 kHz and 10 MHz, and may optionally be about 85 kHz. In one embodiment, the control system 200 may be operable to vary a switching frequency of the inverters 130A-B. As an example, the control system 200 may obtain sensor feedback from a sensor (not shown) and adjust the switching frequency or the duty cycle (e.g., pulse width) based on the sensor feedback.

In an alternative embodiment, the inverters 130A-B may be provided in a half bridge configuration with first and second switches operable to provide power to the transmitter 150A-B.

The switches S1, S2, S3, S4 of the inverters 130A-B may be MOSFETs or any other type of switch capable of selectively supplying power to the transmitter 150A-B, including for example IGBTs. Likewise, the switches of the converter 120 and the grid interface 110 may be any type of switch.

In the illustrated embodiment FIG. 1, the wireless power system 100 is shown in conjunction with multiple remote devices 10A-B in the form of vehicles. The remote devices 10A-B in the form of a vehicle may be a rail car or train car, and the vehicle may include a plurality of receivers configured to receive power from the respective transmitters 10A-B.

The transmitter 150A-B may include a primary coil or primary side coil, and the receiver of the remote device 10A-B may include a secondary coil or a secondary side coil or pickup coil. Power transmitted wirelessly from the transmitter 150A-B to a receiver may be provided to receiver-side circuitry, which may rectify AC power output from the receiver into DC power supplied to a load (e.g., a battery) of the remote device 10A-B. Additional examples of an on-board module are described in U.S. Pub. 2023/0110061 entitled WIRELESS POWER SYSTEM, to Galigekere et al., filed Oct. 4, 2022—the disclosure of which is hereby incorporated by reference herein in its entirety.

The control system 200 may include one or more of the following: an AC current controller 210, a circulating current controller 212 and a submodule balancing controller 214. AC current controller 210 controls the grid current for one of the phases, the circulating current controller 212 reduces the circulating currents between submodules, and the submodule balancing controller 214 maintains the voltage balance between the submodules.

The control system 200 may include electrical circuitry and components to carry out the functions and algorithms described herein. Generally speaking, the control system 200 may include one or more microcontrollers, microprocessors, digital signal processors (DSP), and/or other programmable electronics that are programmed to carry out the functions described herein. The control system 200 may additionally or alternatively include other electronic components that are programmed to carry out the functions described herein, or that support the microcontrollers, microprocessors, and/or other electronics. The other electronic components include, but are not limited to, one or more field programmable gate arrays (FPGAs), systems on a chip, volatile or nonvolatile memory, discrete circuitry, integrated circuits, application specific integrated circuits (ASICs) and/or other hardware, software, or firmware. Such components can be physically configured in any suitable manner, such as by mounting them to one or more circuit boards, or arranging them in other manners, whether combined into a single unit or distributed across multiple units. Such components may be physically distributed in different positions in the system or aspects thereof, or they may reside in a common location within the system or an aspect thereof. When physically distributed, the components may communicate using any suitable serial or parallel communication protocol, such as, but not limited to, CAN, LIN, Vehicle Area Network (VAN), Fire Wire, I2C, RS-232, RS-485, Ethernet, LAN, WiFi, and Universal Serial Bus (USB).

Turning to aspects of the control system 200 for the converter 120, as discussed herein, the converter 120 may include a plurality of converter blocks 124 in one embodiment. The plurality of converter blocks 124 may provide a modular high frequency link that is based on a series-input-parallel-output topology, as shown in FIG. 1. A single-phase MMC may be provided in each converter block 124 and may be configured to generate a high-frequency AC voltage with substantially constant amplitude and frequency. A common closed-loop voltage controller may be adopted to ensure the output high-frequency AC voltage is substantially stable. Series-connected converter blocks 124 on the first DC bus 112 (e.g., the high-voltage DC side) can reduce the voltage stress on each converter block 124, while DC voltage balancing among these converter blocks 124 may be controlled.

Based on (4), the DC voltage across each converter block 124 can be controlled by the sum of the upper arm 121 voltage vₚ and the lower arm 121 voltage vₙ in the single-phase MMC, and the arm voltage may be generated by the capacitor 127 voltages in the inserted SMs 125. To keep the DC voltages among these converter blocks 124 substantially stable and equal, the capacitor 127 voltages in SMs 125 may be balanced. Thus, the net energy stored in the converter block 125 may be targeted as zero, which means the target for the input energy flowing from the first DC bus 112 may be substantially equal with the output energy flowing to that in the second DC bus 122. In one embodiment, considering that all the converter blocks 124 are serially connected at the first DC bus 112, the DC current i_{dc} flows through all the converter blocks 124. When the output power of each converter block 124 is substantially equal and the capacitor 127 voltages in each arm 121 are balanced, the power flowing from the first DC bus 112 into each converter block 124 via the DC current i_{dc} may be substantially or approximately equal, thereby keeping the DC voltage substantially balanced in each converter block 124. It is noted, however, that slight differences in energy distribution are inevitable.

To enhance the stability of the system 100, the control system 200 may implement DC voltage balancing to regulate the energy distribution on each converter block 124. FIG. 5 shows the equivalent circuit of the modular converter 120 when looking from the first DC bus 112 (e.g., from the HV DC-bus side).

The arms 121 of the converter blocks 124 may be serially connected at the first DC bus 121. To keep the DC voltage balance, the DC voltages on the upper and lower arms 121 in each converter block 125 may also be targeted for substantial equality. Thus, the control system 200 may include two main control loops, where one loop is to regulate the energy difference in the upper and lower arms 121 in each converter block 124, and the other loop is to regulate the energy difference in each converter block 124. A portion of the control system 200 is shown in FIG. 6 including a power balance controller 220 according to one embodiment.

For the energy distribution among each converter block 124, the instantaneous power flowing into each converter block 124 can be expressed as

$${p}_{i} = {v}_{dci} \times {i}_{d c} = ( {v}_{p i} + {v}_{n i} + 2 Δ {v}_{i} ) \times {i}_{d c} , \qquad ( 9 )$$

where i_{dc} is the DC current that flows through all series-connected blocks. An energy balance controller 222 may be provided to control such power flow. The energy balance controller 222 ensures that for M block in the power converter architecture, each block would have Vdc/M voltage across each block.

Rewriting (4) to calculate the output AC voltage yields

$${v}_{a c i} = ( {v}_{n i} - {v}_{p i} ) / 2 . \qquad ( 10 )$$

From (9) and (10), Δvᵢ can affect the energy stored in each converter block 124, but it may have little to no effect on the output voltage. Thus, the principle of DC voltage balancing may involve controlling the voltage Δvᵢ to regulate the power flow from the first DC bus 112 to each converter block 124. A balance controller 220 for balancing DC voltage is shown in FIG. 6 as part of the control system 200. v_{dc}/M is the DC voltage reference; v_{cj} is the capacitor voltage of each SM 125 in one converter block 124; i̅_̅{̅c̅j̅}̅ is the DC component of circulating current, which can be calculated from (2) with a low-pass filter. Therefore, in one embodiment, no external current sensor may be used to obtain the DC current i_{dc}.

The balance controller 220 may balances the voltages across each converter arms.

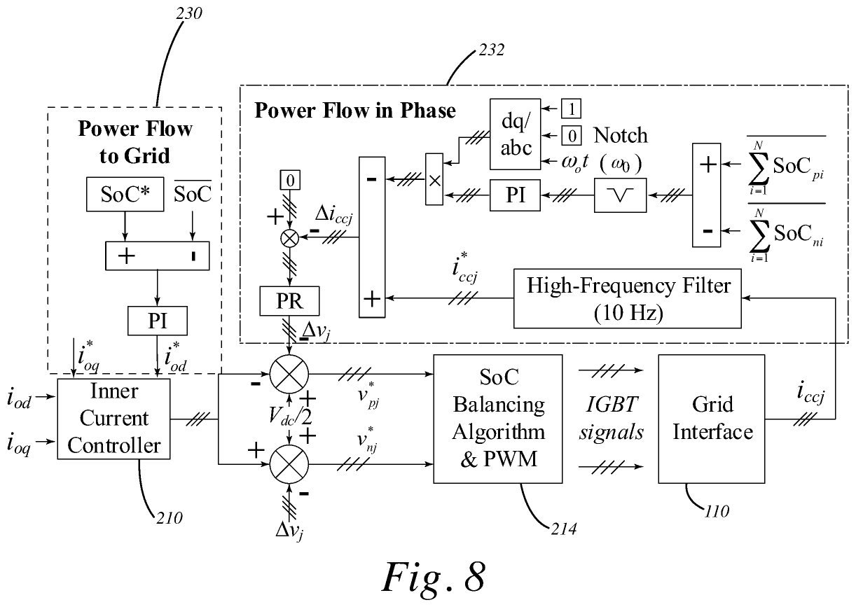

The control system 200 in FIG. 8 may be utilized for a modular system, where v_{od}* is the amplitude of output high-frequency AC voltage, and v_{oq}* equals 0. ω₁ is the set frequency of the AC voltage. For the active rectifier 129, a dual-loop control system may be utilized, where an outer loop is used to control the active and reactive power, and an inner loop is used to track the current reference. The active power reference may be generated from a voltage controller 224 (e.g., a low voltage DC voltage controller), and the power reference to each converter block 124 may be substantially equal to ensure the energy distribution is substantially equal in each converter block 124. A balancing controller 226 may balance the DC bus capacitor voltage for each arm and block of the converter.

With the increasing demand of high-power wireless charging during a short time window for remote devices 10A-B (e.g., electric vehicles), the corresponding impacts caused by high power stress to the power source 50 (e.g., the grid) may become non-negligible as more high-power wireless charging stations are being integrated or connected to the power source 50 (e.g., to the grid). Herein, to reduce the power stress to the power source 50, battery energy storage systems (BESSs) may be integrated in the SMs 114 of the system 100 to reshape the load profile.

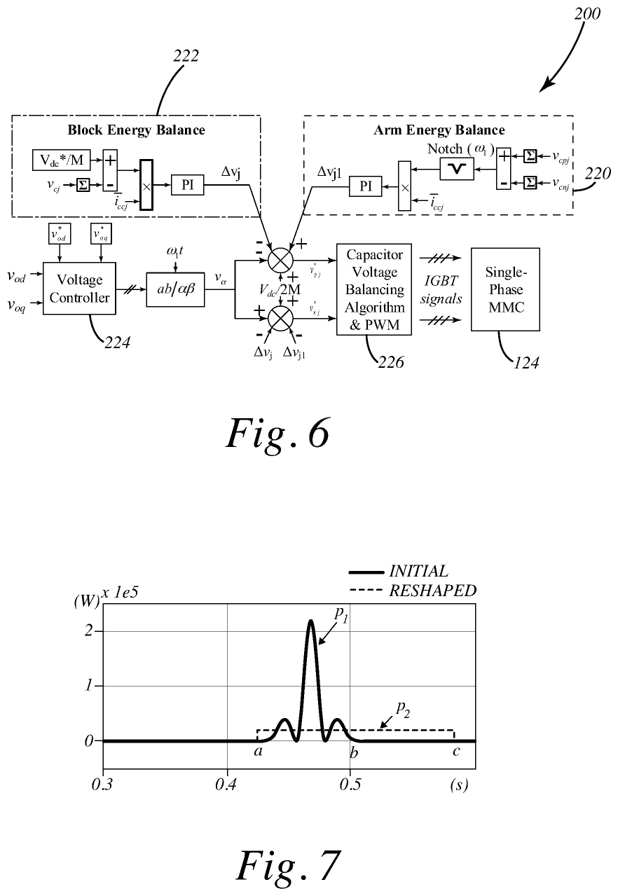

As shown in FIG. 7, p₁ is the initial high-power pulse-like shape with short charging time, and p₂ is the reshaped lower power with longer charging time.

The total energy with different charging curves may be similar or identical according to the following:

$${v}_{a c i} = ( {v}_{n i} - {v}_{p i} ) / 2. \qquad ( 11 )$$

$${\int }_{a}^{b} {p}_{1} ( t ) dt = {\int }_{a}^{c} {p}_{2} ( t ) dt . \qquad ( 12 )$$

To achieve similarity or equality in total energy, the AC power and the DC power of grid interface 110 may be decoupled from each other. From (4) and FIG. 3, the DC power related to the DC voltage v_{dc} can be regulated by the sum of the upper arm 121 voltage vₚ and the lower arm 121 voltage vₙ; and the AC power related to the AC current i_{oabc} can be regulated by the difference between vₚ and vₙ. In this way, the grid interface 110 can separately control the power flows at the AC and DC sides. At the DC side, the grid interface 110 may operate as a voltage source to keep the voltage stable on the first DC bus 112 (e.g., to stabilize the high-voltage DC-bus voltage); at the AC side (e.g., the side of the power source 50), the grid interface 110 may operate as a current source to control the power flow from the power source 50 (e.g., AC power grid). The energy gap between the AC and DC sides of the grid interface 110 may be filled by the distributed energy units 115.

According to the analysis in FIG. 3, the AC current iₒ may be used to regulate the energy stored in each phase. Under normal grid conditions, the AC currents may be balanced and sinusoidal, thus in the synchronous dq axis, the d-axis current reference i*_{od} is derived from the average state of charge (SoC) controller to regulate the power flow from the AC power grid and grid interface 110; and the q-axis current reference i*_{oq} may be set to zero for unity power factor control. For the grid ancillary service, i*_{od} and i*_{oq} can be set based on frequency and voltage regulations.

The circulating current i_{cc} may be used to regulate the energy stored between the upper and lower arms 121. Based on the analysis in FIG. 3, a circulating current with the same frequency of AC voltage may be injected, and the amplitude of such circulating current may depend on the SoC difference between the upper and lower arms 121.

A portion of the control system 200 according to one embodiment is shown in FIG. 8. The control system 200 in the illustrated embodiment may provide control for a BESS based grid interface 110. The control system 200 in the illustrated embodiment includes two main control loops.

One loop is implemented by a source power flow controller 230 to control the average SoC of energy units 115 in the grid interface 110 by regulating the power flow to the power source 50 (e.g., the AC grid). The source power flow controller 230 may determine the grid current based on the target (reference) and actual state-of-charge (SOC).

Another loop implemented by a phase flow controller 232 may keep the SoC of the energy units 115 between the upper and lower arms 111 balanced by regulating the power flow in each phase. An SoC based sorting-and-selecting controller may be used in one embodiment to keep the SoC within the limits. The phase flow controller 232 may control the current for each phase depending on the target grid current and state-of-charge targets and limits.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. An off-board module of a dynamic wireless power transfer (DWPT) system for providing high-frequency AC power to an electric vehicle (EV), the off-board module comprising:
a high-voltage bus;
a grid-interface module electrically connected at its input directly to a grid that provides three-phase AC voltage with a medium amplitude and at its output directly to the high-voltage bus, wherein the grid-interface module is configured to:
convert the three-phase AC voltage with the medium amplitude to a DC voltage having a high amplitude that is larger than the medium amplitude of the three-phase AC voltage, and
output the DC voltage with the high amplitude to the high-voltage bus;
a low-voltage bus including a DC capacitance C_{dc};
a DC/DC converter module electrically connected at its input directly to the high-voltage bus and at its output directly to the low-voltage bus, wherein the DC/DC converter module is configured to:
convert the DC voltage with the high amplitude to a DC voltage with a low amplitude that is less than the medium amplitude of the three-phase AC voltage, and
output the DC voltage with the low amplitude to the low-voltage bus;
a resonant network configured to produce a high-frequency AC current from a high-frequency AC voltage;
a DC/AC converter electrically connected between the low-voltage bus and the resonant network, wherein the DC/AC converter is configured to convert the DC voltage with the low amplitude to the high-frequency AC voltage; and
a primary coil electrically connected to the resonant network and configured to wirelessly transmit the high-frequency AC power corresponding to the high-frequency AC current to a pick-up coil of an onboard module of the DWPT system when the pick-up coil is adjacent to the primary coil over a time interval during which the EV moves by the primary coil.

2. The off-board module of claim 1, wherein:
the grid-interface module includes three arms in one-to-one correspondence to the AC voltage's three-phases;
each arm includes N submodules, where N≥2; and
each of the N submodules include a respective half-bridge converter and a respective energy unit.

3. The off-board module of claim 2, wherein the energy unit includes a battery or a supercapacitor.

4. The off-board module of claim 1, wherein:
the DC/DC converter module is arranged based on a series-input-parallel-output topology and includes K blocks connected in series with each other, where K≥2;
each of the K blocks include a single-phase modular multilevel converter (MMC) at its primary side and a respective set of one or more single-phase active rectifiers at its secondary side;
each arm of the single-phase MMC includes M submodules, where M≥2; and
each of the M submodules include a respective half-bridge converter and a respective capacitor.

5. The off-board module of claim 4, comprising:
K copies of the DC/AC converter in one-to-one correspondence with the K blocks of the DC/DC converter module; and
respective K copies of the resonant network and respective K copies of the primary coil to enable the DWPT system to provide the high-frequency AC power concurrently to up to K EV vehicles.

6. The off-board module of claim 1, comprising:
a grid-interface controller communicatively coupled with, and configured to drive, the grid-interface module including a plurality of submodules in at least two arms of the grid-interface; and
a DC/DC converter controller communicatively coupled with, and configured to drive, the DC/DC converter module including a plurality of submodules in at least two arms of the DC/DC converter.

7. The off-board module of claim 6, wherein the grid-interface controller is configured to drive the grid-interface module to control the flow of power from an energy source of the plurality of submodules to the respective arm of the grid-interface.

8. The off-board module of claim 1, wherein the fundamental component of the high-frequency AC power has a frequency of 85 kHz.

9. A dynamic wireless power transfer (DWPT) system comprising:
the off-board module according to claim 1; and
one or more on-board modules carried by respective EVs, each on-board module including:
a respective pick-up coil configured to receive the high-frequency power when the pick-up coil is adjacent to a corresponding copy of the primary coil over a time interval during which the EV carrying the on-board module moves by the corresponding copy of the primary coil; and
a respective rectifier configured to provide DC power based on the received high-frequency power.

10. The DWPT system of claim 4 wherein the DC/DC converter module includes at least five blocks.

11. An extra fast charging (XFC) system for wirelessly providing AC power to an electric vehicle (EV), the XFC system including the DWPT system of claim 9.

12. A wireless power supply for a remote device, the wireless power supply comprising:
a high-voltage bus;
a power source interface operable to couple directly to a grid power source that provides three-phase AC voltage with a first AC amplitude, the power supply interface configured to convert the three-phase AC voltage to output a first DC voltage level on a first DC bus;
a converter electrically coupled to the output of the power source interface, the converter configured to convert the first DC voltage level to a second DC voltage level on a second DC bus, the converter including a plurality of converter modules each including a converter module output coupled to the second DC bus, each of the converter modules configured to provide the second DC voltage level to the converter module output;
a first wireless power transmitter; and
first switching circuitry operably coupled to the second DC bus and the first wireless power transmitter, the first switching circuitry configured to drive the first wireless power transmitter with power obtained from the second DC bus to transmit power wirelessly to the remote device.

13. The wireless power supply of claim 12 wherein:
the power source interface includes a grid-interface module electrically connected at its input directly to the grid power source that provides the three-phase AC voltage, wherein the grid-interface module is configured to:
convert the three-phase AC voltage to a first DC voltage with the first DC voltage level; and
output the first DC voltage to the output of the power supply interface;
a DC capacitance C_{dc} is coupled to the second DC bus;
the first wireless power transmitter includes a first resonant network and a primary coil;
a DC/AC converter electrically connected between the second DC bus and the first resonant network; and
the primary coil is configured to wirelessly transmit power to a pick-up coil of an on-board module when the pick-up coil is adjacent to the primary coil over a time interval during which the remote device moves by the primary coil.

14. The wireless power supply of claim 12 wherein the first DC level is greater than the first AC amplitude, and wherein the first DC level is greater the second DC level.

15. The wireless power supply of claim 12 comprising:
a second wireless power transmitter;
second switching circuitry operably coupled to the second DC bus and the second wireless power transmitter, the second switching circuitry configured to drive the second wireless power transmitter with power obtained from the second DC bus to transmit power wirelessly to the remote device.

16. The wireless power supply of claim 12 wherein the plurality of converter modules are provided in a series arrangement with the first DC bus.

17. The wireless power supply of 12 wherein:
the power source interface includes three arms in one-to-one correspondence to the AC voltage's three-phases;
each arm includes N submodules, where N≥2; and
each of the N submodules includes a respective half-bridge converter and a respective energy unit.

18. The wireless power supply of claim 12 wherein each of the plurality of converter modules a single-phase modular multilevel converter (MMC) at its primary side and a respective set of one or more single-phase active rectifiers at its secondary side.

19. The wireless power supply of claim 18 wherein:
each arm of the single-phase MMC includes M submodules, where M≥2; and
each of the M submodules includes a respective half-bridge converter and a respective capacitor.
